(19) United States
(12) Patent Application Publication
(10) Pub. No.: US 2007/0132883 A1
(43) Pub. Date: Jun. 14, 2007

(54) On-screen display device and control method therefor

(75) Inventors: Nobuyuki Hattori, Kasugai (JP); Kazuhiko Okada, Kasugai (JP); Chihiro Sekiya, Kasugai (JP); Kiichiro Iga, Kasugai (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/398,689

(22) Filed: Apr. 6, 2006

(30) Foreign Application Priority Data
Dec. 12, 2005 (JP) 2005-357207

(51) Int. Cl. H04N 11/00

(52) U.S. Cl. 348/468

(57) ABSTRACT

An OSD device is provided which allows a reduction in the capacity of a memory for storing OSD data and also allows the efficient use of a transfer frequency band in the transfer of the OSD data. A management information data set MD includes, for the display position of each of OSD data sets OD to be superimposed on sensed image data sets SD, display position information sets HDISP and VDISP on the OSD data set OD and a storage location information set WORD on the OSD data set OD. The on-screen display device comprises an OSD data storage region (32) for storing the OSD data sets OD, senses the management information data set MD having HDISP and VDISP which match the display position of each of the sensed image data sets SD, and retrieves the OSD data sets stored in WORD included in the management information data set MD from the OSD data storage region (32).

### CROSS-REFERENCE TO RELATED APPLICATIONS

This application is based upon and claims the benefit of priority from each of the prior Japanese Patent Application No. 2005-357207 filed on Dec. 12, 2005, the entire contents of which are incorporated herein by reference.

### BACKGROUND OF THE INVENTION

1. Field of the Invention

The present invention relates to an image display device and, more particularly, to an image display device such as an on-screen display device which displays raster images of font data, picture data, and the like in superimposed relation on parts of a frame image.

2. Description of Related Art

In an image display device such as an on-screen display (hereinafter also referred to as OSD) device, a plurality of raster images of font data, picture data, and the like are displayed in superimposed relation on parts of a frame image serving as a background. For example, in various display devices which display frame images such as a digital still camera and a digital video camera, a display of a setting related to image display such as white balance, a display image, a shooting date, an image title, a display of a message, and the like correspond to raster images displayed on parts of a frame image.

The OSD device disclosed in Japanese Unexamined Patent Publication No. 2003-15624 comprises: a display data memory 1 (212) for storing only background image data; and a display data memory 2 (213) for storing synthesized image data resulting from synthesis between the background image data an OSD data, as shown in FIG. 10. By selecting either of the display data memory 1 (212) and the display data memory 2 (213) with a selector 216, the OSD device enables switching to display or non-display of the OSD data on a display unit 206. When the content/position of a display is to be changed, background image data is transferred from the display data memory 1 (212). This allows individual storage of the background image data and the synthesized image data with the OSD data without the need for re-conversion of the current image data.

### SUMMARY OF THE INVENTION

However, the OSD device using the technology disclosed in Japanese Unexamined Patent Publication No. 2003-15624 requires not only a background image area 201 but also an OSD data area 202 having the same area size as the background image area 201, the display data memory 1 (212), and the display data memory 2 (213). Accordingly, it becomes necessary for the OSD device to have a memory with a large capacity and the problem of a cost increase is incurred.

In addition, because the OSD data is composed of a combination of small-size data sets such as character data sets and is primarily displayed as supplementary information for a background image such as image information or a date, it is displayed on a part of the background image. It follows therefore that, when the OSD data developed in the OSD data area 202 is to be superimposed on the background image area 201, the OSD data area 202 of the same size as the data capacity of the background image area 201 is transferred irrespective of the size of the OSD data. When a portion displaying the OSD data is small in size, data for a blank portion which does not contain characters or the like is transferred in a large quantity, which causes the problem of waste in a transfer frequency band.

The present invention has been achieved in view of the problems of the prior art technology mentioned above and it is therefore an object of the present invention to provide an OSD device which allows a reduction in the capacity of a memory for storing OSD data and also allows the efficient use of a transfer frequency band.

In order to achieve the above object, there is provided an on-screen display device for outputting second data sets in superimposed relation on parts of first data sets, said device comprising:

a second data sets storage unit for storing said second data sets at individual specified storage locations;

a management information storage unit for storing, for a display position of each of said second data sets superimposed on said first data sets, a management information set including a second data display position information set indicative of the display position of said second data set and a second data storage location information set indicative of a storage location of the second data set;

a management information acquisition unit for retrieving, from said management information storage unit, said management information sets having the second data display position information sets which match said first data display position as acquired management information sets; and

an output control unit for retrieving, from said second data sets storage unit, said second data sets to be stored in said second data storage location information sets included in said acquired management information sets.

Furthermore, there is provided a method for controlling an on-screen display device for outputting second data sets in superimposed relation on parts of first data sets, said device comprising: a second data sets storage unit for storing said second data sets at individual specified storage locations; and a management information storage unit for storing, for a display position of each of said second data sets superimposed on said first data sets, a management information set including a second data display position information set indicative of the display position of said second data set and a second data storage location information set indicative of a storage location of the second data set, said method comprising the steps of:

retrieving, from said management information storage unit, said management information sets having the second data display position information sets which match said first data display position as acquired management information sets; and

retrieving, from said second data sets storage unit, said second data sets to be stored in said second data storage location information sets included in said acquired management information sets.

Since it is sufficient for the second data sets storage unit to store only the second data sets outputted in superimposed relation, the second data sets storage unit need not have the same capacity as the first storage unit. Compared with the prior art technology, the arrangement needs only a small memory area. In addition, the amount of data transfer resulting from the storage of the second data sets can also be reduced and the transfer frequency band can be used more efficiently without incurring waste.

The above and further objects and novel features of the invention will more fully appear from the following detailed description when the same is read in connection with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a functional block diagram showing a structure of an OSD device according to an embodiment of the present invention;

FIG. 2 is a view showing an example of a display output from the OSD device;

FIG. 3 is a view showing an example of OSD data sets;

FIG. 4 is a view showing an example of management information data sets;

FIG. 5 is a functional block diagram showing a structure of a color conversion unit;

FIG. 6 is a flow chart showing a procedure for a management information data alignment process;

FIG. 7 is a flow chart showing a procedure for a repeating process;

FIG. 8 is a flow chart showing a procedure for a vertical enlargement process;

FIG. 9 is a flow chart showing a procedure for a horizontal enlargement process; and

FIG. 10 is a functional block diagram showing an OSD device according to a prior art technology.

### DETAILED DESCRIPTION OF THE PREFERRED EMBODIMENTS

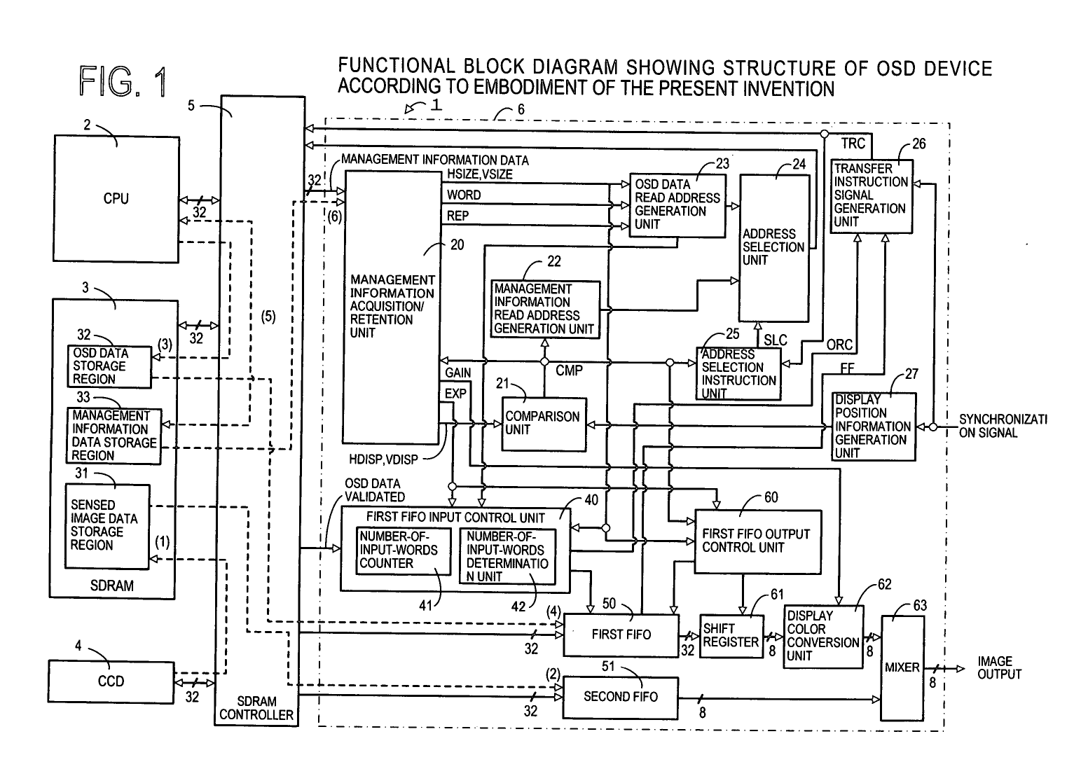

Referring to FIGS. 1 to 9, a specified embodiment of an OSD device according to the present invention will be described herein below in detail.

FIG. 1 is a functional block diagram showing an OSD device 1 according to the present embodiment.

The OSD device 1 comprises: a well known CPU 2 for performing the transfer and processing of data; a SDRAM 3 for storing data; a CCD 4 for sensing an image; an SDRAM controller 5 for controlling an access to the SDRAM 3; and an image processor 6 for receiving each data set stored in the SDRAM 3 therefrom and outputting an image signal.

In the SDRAM 3, there are arranged: a sensed image data storage region 31 for storing sensed image data resulting from the image sensing by the CCD 4; an OSD data storage region 32 for storing OSD data; and a management information data storage region 33 for storing management information data sets MD showing a display position and the like upon the outputting of the OSD data sets OD.

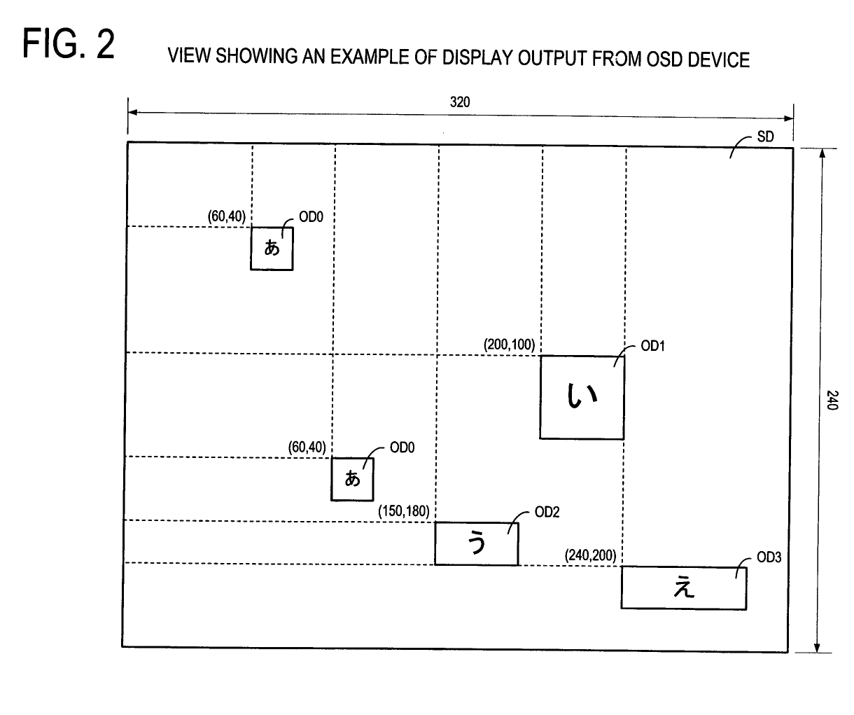

As shown in an example of a display output in FIG. 2, the OSD device 1 superimposes the OSD data sets OD on parts of the sensed image data sets SD resulting from the image sensing by the CCD 4 and outputs them. On outputting the OSD data sets OD, the OSD device 1 outputs them, while referencing the management information data sets MD corresponding to the display positions of the OSD data sets OD. In the example of the display output of FIG. 2, the coordinates of the sensed image data sets SD are such that the upper left point is the origin (0, 0) and the lower right point is the maximum coordinate point (319, 239). The numbers inside the parentheses indicate the coordinates at which the OSD data sets are placed. For example, it is indicated that the OSD data set “ [symbol] ” is at the position where the horizontal direction=60 and the vertical direction=40.

In the OSD device 1 according to the present embodiment, the positions of the OSD data sets OD are determined such that another OSD data set is not positioned in overlapping relation on the same scan line.

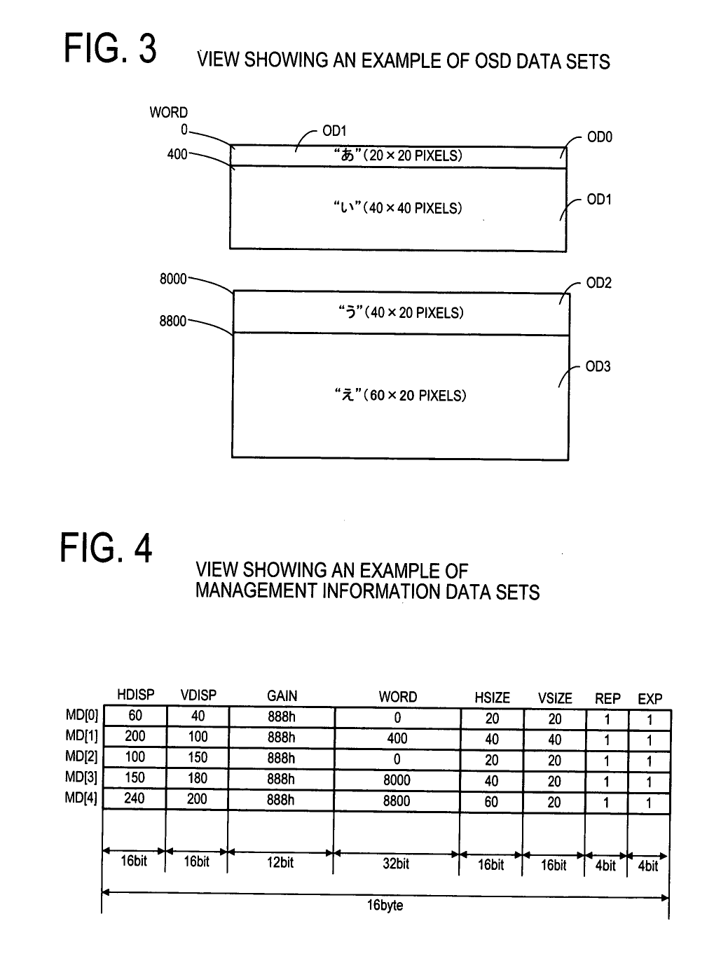

A description will be given next to the OSD data sets OD and the management information data sets MD with reference to FIGS. 3 and 4.

FIG. 3 shows an example of the OSD data sets OD. In the OSD data storage region 32 (see FIG. 1) provided in the SDRAM 3, a plurality of OSD data sets OD are stored as bit map data sets at individual specified storage addresses. For example, the drawing shows that an OSD data set OD0 of 20×20 pixels which represents “ [symbol] ” is stored at the addresses 0 to 399 in the OSD data storage region 32. Other OSD data sets OD are also stored in the same manner as the OSD data set OD0.

FIG. 4 shows an example of the management information data sets MD. In the management information data storage region 33 (see FIG. 1) provided in the SDRAM 3, a plurality of management information data sets MD are stored. For the display position of each of the OSD data sets OD, the management information data set MD includes, as elements, a horizontal display position HDISP, a vertical display position VDISP, a display color information set GAIN, a storage head address WORD, the number of horizontal pixels HSIZE, the number of vertical pixels VSIZE, a number-of-repeat-times information set REP, and an enlargement factor EXP. The management information data sets MD have been aligned such that the display positions thereof based on the horizontal display positions HDISP and the vertical display positions VDISP are in the order in which they are displayed (in the order in which they are scanned) before they are stored in the management information data storage region 33.

Each of the horizontal display position HDISP and the vertical display position VDISP is a 16-bit data set indicative of the position of the displayed OSD data in the direction (hereinafter also referred to as the horizontal direction) along a scan line or in the direction (hereinafter also referred to as the vertical direction) orthogonal to the direction along the scan line.

The display color information set GAIN is a gain with respect to the OSD data set OD, which is a 12-bit RGB data set composed of 4 bits for the color R, 4 bits for the color G, and four bits for the color B. The most significant bit of the 4 bits composing any of RGB corresponds to an integral part and the three less significant bits thereof correspond to a decimal part.

The storage head address WORD is a 32-bit data set indicative of the head address of the OSD data set OD stored in the management information data storage region 33.

Each of the number of horizontal pixels HSIZE and the number of vertical pixels VSIZE is a 16-bit data set showing the number of horizontal pixels or vertical pixels in the OSD data set OD.

The number-of-repeat-times information set REP is a 4-bit data set for specifying the number of repeat times for a repeating process which repeatedly places the OSD data set OD in the horizontal direction when the OSD data set OD is placed in superimposed relation on the sensed image data set SD. As shown in FIG. 4, when the value is 1, one OSD data set OD is placed.

The enlargement factor EXP is a 4-bit data set for specifying a scaling factor for an enlargement process which enlarges the OSD data set OD in the horizontal and vertical directions. As shown in FIG. 4, when the value is 1, full-size display is performed

Referring back to FIG. 1, the image processor 6 will be described.

The image processor 6 comprises: a management information acquisition/retention unit 20; a comparison unit 21; a management information read address generation unit 22; an OSD data read address generation unit 23; an address selection unit 24; an address selection instruction unit 25; and a transfer instruction signal generation unit 26 as parts related to address control when the management information data set MD is read from the SDRAM 3 and when an access is made to the SDRAM 3.

The image processor 6 also comprises: a first FIFO input control unit 40; a first FIFO 50 for storing the OSD data set OD; a second FIFO 51 for storing the sensed image data sets SD; a first FIFO output control unit 60; a shift register 61; a display color conversion unit 62; and a mixer 63 as parts related to the processing of the sensed image data sets SD and the OSD data sets OD. The capacity of the first FIFO 50 has been adjusted to 1200 bytes corresponding to the maximum one of the sizes of the OSD data sets OD. In the first FIFO 50, only the same OSD data set OD is stored. Accordingly, the first FIFO 50 of the OSD device 1 according to the present embodiment which has been set to the same capacity as the maximum size of the OSD data set OD incurs no area waste.

Each of the broken lines in FIG. 1 indicates the flow of data between the individual units. The broken line (1) indicates the flow of the sensed image data SD resulting from the image sensing by the CCD 4 and stored in the sensed image data storage region 31. The broken line (2) indicates the flow of the sensed image data SD stored in the sensed image data storage region 31 and transferred to the second FIFO 51. The broken line (3) indicates the flow of the OSD data OD stored in the OSD data storage region 32. The broken line (4) indicates the flow of the OSD data OD stored in the OSD data storage region 32 and transferred to the first FIFO 50. The broken line (5) indicates the flow of data accessed between the CPU 2 and the management information data storage region 33. The broken line (6) indicates the flow of data transferred from the management information data MD stored in the management information data storage region 33 to the management information acquisition/retention unit 20.

The management information acquisition/retention unit 20 retrieves and retains the management information data set MD stored in the management information data storage region 33 of the SDRAM 3 via the SDRAM controller 5. The comparison unit 21 compares the display position signal indicative of the display position of the sensed image data set SD from an image display control unit not shown with each of the horizontal display position HDISP and the vertical display position VDISP from the management information acquisition/retention unit 20. When they match, the management information acquisition/retention unit 20 activates a match detection signal CMP. When the match detection signal CMP is activated, the management information acquisition/retention unit 20 replaces the retained management information data set MD with the next management information data set MD to be stored in the management information data storage region 33.

The management information read address generation unit 22 generates addresses for retrieving the management information data sets MD aligned in the order in which they are displayed from the management information data storage region 33 in the order they are stored. Specifically, the storage addresses of the management information data sets are generated by using an address counter not shown, which is updated on a transition edge when the match detection signal CMP is activated.

The OSD data read address generation unit 23 receives the number of horizontal pixels HSIZE, the number of vertical pixels VSIZE, the storage head address WORD, and the number-of-repeat-times information set REP from the management information acquisition/retention unit 20 and generates the addresses of the OSD data set OD to be transferred to the first FIFO 50. Specifically, the addresses are generated successively in the range of the storage head address WORD to an address obtained by adding, to the storage head address WORD, the number of pixels in the OSD data OD obtained from the number of horizontal pixels HSIZE and the number of vertical pixels VSIZE. When the number-of-repeat-times information set REP is other than 1, the same address is repeatedly generated in accordance with the number of times specified by the number-of-repeat-times information set REP, as will be described later.

The address selection unit 24 receives an address value from the management information read address generation unit 22 and an address value from the OSD data read address generation unit 23 and selects either of the address values in accordance with a selection instruction signal SLC from the address selection instruction unit 25.

The address selection instruction unit 25 receives the match detection signal CMP and a transfer instruction signal TRC, which will be described later, and outputs the selection instruction signal SLC to the address selection unit 24. When the match detection signal CMP is activated, the address selection instruction unit 25 outputs an OSD data read address selection to the selection instruction signal SLC. When the transfer instruction signal TRC is activated, the address selection instruction unit 25 outputs a management information read address selection to the selection instruction signal SLC. However, when the match detection signal CMP and the transfer instruction signal TRC are simultaneously activated, the match detection signal CMP is preferred to the transfer instruction signal TRC. Accordingly, the transfer instruction signal generation unit 26 monitors the selection instruction signal SLC and retains the active state of the transfer instruction signal TRC till the outputting of the management information read address selection.

The transfer instruction signal generation unit 26 monitors a first FIFO full signal FF from the first FIFO 50 and outputs the transfer instruction signal TRC when there is a vacancy and there is a need to transfer the OSD data set OD to the first FIFO 50, which will be described later.

A display position information generation unit 27 receives a synchronization signal composed of a horizontal synchronization signal, a vertical synchronization signal, and a display clock when image data obtained by superimposing the OSD data sets OD on parts of the sensed image data sets SD is displayed and outputs the horizontal display position and the vertical display position as the current display positions to the comparison unit 21. Specifically, the display position information generation unit 27 comprises two counters for counting the horizontal display position and the vertical display position, which are not shown. In the counter for counting the horizontal display position, the count value is initialized by each horizontal synchronization signal and incremented by each display clock in synchronization with image display. In the counter for counting the vertical display position, the count value is initialized by each vertical synchronization signal and incremented by each horizontal synchronization signal. This allows the generation of the horizontal and vertical display positions of a displayed image.

The first FIFO input control unit 40 performs control of an input to the first FIFO 50 and includes a number-of-input-words counter 41 and a number-of-input-words determination unit 42. The number-of-input-words counter 41 counts OSD data validate signals. As a result, every time the OSD data set OD is inputted, the number of words in the OSD data set OD is counted. The number-of-input-words determination unit 42 determines whether or not the count value from the number-of-input-words counter 41 has reached the number of pixels obtained based on the number of horizontal pixels HSIZE and the number of vertical pixels VSIZE from the management information acquisition/retention unit 20 and outputs an OSD data request signal ORC when the count value has not reached it.

The first FIFO output control unit 60 performs a control operation for reading the OSD data set OD with the number of words obtained based on the number of horizontal pixels HSIZE and the number of vertical pixels VSIZE in response to the match detection signal CMP from the comparison unit 21. When the enlargement factor EXP is other than 1, the first FIFO output control unit 60 performs the enlargement process which will be described later.

In the shift register 61, the OSD data set OD composed of a plurality of pixels read from the first FIFO 50 is latched and successively shifted in accordance with the value of the enlargement factor EXP to be outputted on a pixel-by-pixel basis.

For example, when EXP=1 is satisfied, the data set stored in the shift register is shifted and outputted on an every one-pixel basis. When EXP=2 is satisfied, the data set stored in the shift register is shifted and outputted on an every two-pixel basis.

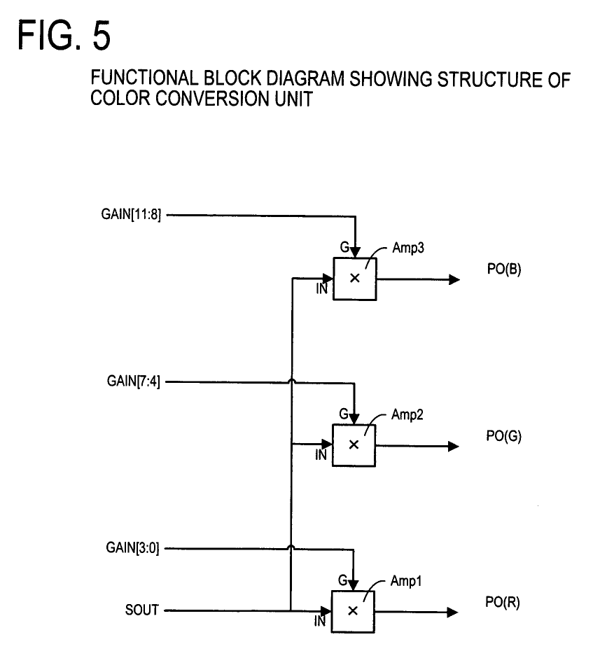

The display color conversion unit 62 performs an arithmetic operation using the corresponding display color information set GAIN as a gain and outputs output signals PO(R), PO(G), and PO(B) for the individual colors of RGB. Specifically, as shown in FIG. 5, the display color conversion unit 62 includes three amplifiers Amp1, Amp2, and Amp3. To the respective gain terminals G of the amplifiers Amp1, Amp2, and Amp3, display color information sets GAIN [3:0], GAIN [7:4], and GAIN [11:8] are connected. To each of the respective input terminals IN, an output signal SOUT is connected. The display color information set GAIN [11:8] represents a 4-bit data (blue (B) information) set corresponding to the bits 11 to 8 of the display color information set GAIN. The same shall apply to the display color information sets GAIN [7:4] and GAIN [3:0]. The output signal SOUT is amplified in accordance with the level of each of the display color information sets GAIN and outputted to the output signals PO(R), PO(G), and PO(B). As a result, in the OSD device 1 according to the present embodiment, the display color conversion unit 62 can convert the display color of the OSD data set OD based on the display color information sets GAIN.

In the mixer 63, the OSD data sets OD outputted from the display color conversion unit 62 are superimposed on the sensed image data sets SD outputted from the second FIFO 51 and outputted to a display unit not shown.

A description will be given herein below to an operation when the OSD device 1 according to the present embodiment outputs the display shown in FIG. 2.

The sensed image data sets SD fetched by using the CCD 4 are stored in the sensed image data storage region 31 along the path (1) in FIG. 1. The sensed image data sets SD stored in the sensed image data storage region 31 are stored in the second FIFO 51 along the path (2) and outputted to an image output via the mixer 63 so that they are brought into the state displayed in a frame in synchronization with the display clock, as shown in FIG. 2.

On the other hand, the OSD data sets OD have been stored preliminarily in the OSD data storage region 32 from another memory device not shown along the path (3) in FIG. 1.

The management information data sets MD stored in the management information data storage region 33 as shown in FIG. 4 have been preliminarily aligned by the CPU 2 using a management information data alignment process (along the path (5) in FIG. 1), which will be described later, so that the display positions of the OSD data sets OD are in the order in which they are displayed. The management information read address generation unit 22 has outputted the head address of the management information data storage region 33 as an initial value. Accordingly, the MD[0] as the head elements of the management information data sets MD are fetched by the management information acquisition/retention unit 20 (along the path (6) in FIG. 1) so that the management information acquisition/retention unit 20 retains the individual elements of MD[0]. In other words, HDISP=60, VDISP=40, GAIN=888h, WORD=0, HSIZE=20, VSIZE=20, REP=1, and EXP=1 have been outputted.

The OSD data read address generation unit 23 generates the head address of the OSD data storage region 32 as the address for causing an access to 0 based on WORD=0. The address value is incremented every time the OSD data set OD is transferred and outputted till the OSD data sets OD corresponding to 400 pixels, obtained by multiplying HSIZE=20 and VSIZE=20 together, are transferred.

In the comparison unit 21 to which HDISP=60 and VDISP=40 are inputted, when the display positions of the frame outputted from the display position information generation unit 27 reach Horizontal Direction=60 and Vertical Direction=40, the match detection signal CMP is outputted.

The address selection instruction unit 25 outputs the signal selection instruction signal SLC for selecting the output from the OSD data read address generation unit 23 in response to the match detection signal CMP, while the head address of the OSD data storage region 32 is outputted to the SDRAM controller 5. From the management information data storage region 33, the OSD data set OD is outputted along the path (4) in FIG. 1 to the first FIFO 50 via the SDRAM controller 5. On the other hand, the transfer instruction signal generation unit 26 outputs the control signal TRC related to the transfer of the OSD data set OD.

The first FIFO 50 outputs the first FIFO full signal FF when there is no more vacant region for storing data. In the transfer instruction signal generation unit 26, the outputting of the transfer instruction signal TRC therefrom is suppressed in response to the first FIFO full signal FF and the transfer of the OSD data set OD0 from the OSD data storage region 32 to the first FIFO 50 is also halted.

On the other hand, the OSD data set OD0 (the display showing “ [symbol] ” in the upper left portion of FIG. 2) stored in the first FIFO 50 is outputted in synchronization with the display clock to the image output via the shift register 61, the display color conversion unit 62, and the mixer 63 and displayed in the frame. When the region for storing data is thus recovered in the first FIFO 50, the first FIFO full signal FF is inactivated, the transfer instruction signal TRC from the transfer instruction signal generation unit 26 is outputted again, and the transfer of the OSD data set OD from the OSD data storage region 32 to the first FIFO 50 is resumed.

Since the OSD device 1 according to the present embodiment temporarily stores the OSD data set OD in the first FIFO 50 and then outputs it, data transfer from the SDRAM 3 can be performed continuously so long as the first FIFO 50 has a region for storing data. The arrangement is preferable particularly when a burst transfer is performed.

The OSD device 1 according to the present embodiment also controls data transfer to the first FIFO 50 based on the first FIFO full signal FF. As a result, even when the capacity of the first FIFO 50 is smaller than the size of the OSD data OD, a reliable transfer can be performed.

In addition, the management information read address generation unit 22 advances the output address by one position in response to the match detection signal CMP. As a result, the MD[1] located at the next address Head Address+1 in the management information data storage region 33 is accessed and the data of the MD[1] is fetched by the management information acquisition/retention unit 20 so that the output from the management information acquisition/retention unit 20 is updated to HDISP=200 and VDISP=100.

In the OSD device 1 according to the present embodiment, the management information data sets MD aligned in the order they are displayed and stored in the management information data storage region 33 are read successively. This allows the retrieval of the various information of the OSD data sets OD displayed in the frame. As a result, the management information acquisition/retention unit 20 and the management information read address generation unit 22, each having a simple structure, are sufficient to perform the required functions.

When the display positions of the frame outputted from the display position information generation unit 27 reach Horizontal Position=200 and Vertical Position=100, the match detection signal CMP is outputted. Thereafter, the same operation as when the OSD data OD0 is displayed is performed so that an OSD data set OD1 (“ [symbol] ” in FIG. 2) is displayed. Further thereafter, MD[2] to MD[4] are also referenced in the same manner as described above and the corresponding OSD data sets OD are displayed in the frame.

In the OSD device 1 according to the present embodiment, the storage region related to the display of the OSD data sets OD can be limited to the OSD data storage region 32 and to the management information data storage region 33. Compared with the case where the OSD data sets OD are stored in a storage region of the same size as the sensed image data storage region 31, a smaller storage region is sufficient to store a required amount of data. In addition, a narrower transfer frequency band is also sufficient since the target of transfer is only the OSD data sets to be displayed.

In the OSD device 1 according to the present embodiment, the management information data sets MD are aligned such that the vertical display positions VDISP included in the management information data sets MD are in the order in which they are displayed before the management information data sets MD are stored in the management information data storage region 33 and processed. In the present embodiment, the alignment process is performed by using the CPU 2 in accordance with a bubble sort algorithm. A description will be given herein below to a procedure for aligning the management information data sets MD.

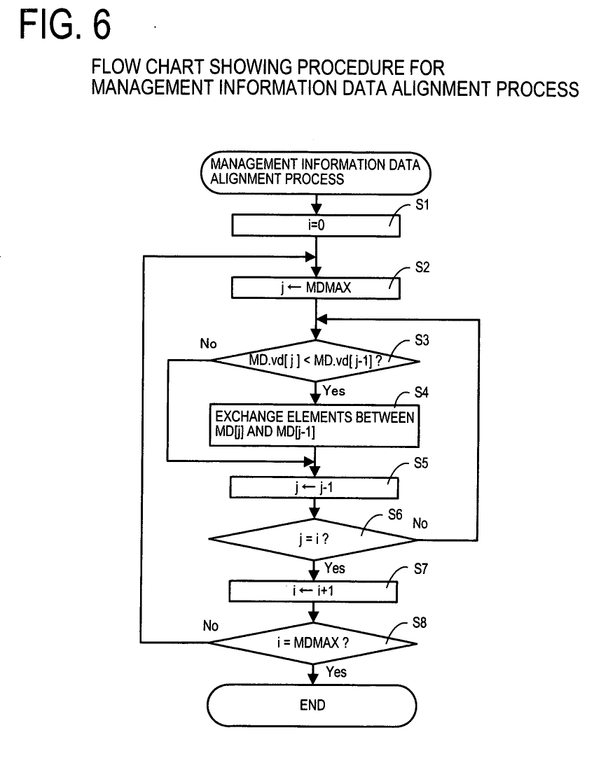

FIG. 6 is a flow chart showing the procedure for aligning the management information data sets MD.

In the following description, it is assumed that MD[n] shows the (n+1)-th management information data set MD to be stored and MD[MDMAX] is the final one of the management information data sets MD. In addition, MD[n] is defined as a structure and includes the vertical display position VDISP as one of the elements thereof. The vertical display position VDISP as the element is represented as MD. vd[n]. The variable i and the variable j are defined in the CPU 2 and then used.

First, in Step S1, the variable i indicative of the head of an unsorted portion in a sorting process is initialized to 0.

In Step S2, the variable j indicative of the target position of the sorting process is initialized to a constant MDMAX.

In Step S3, a comparison is made between the value of the vertical display position MD. vd[j] of MD[j] and the value of the vertical display position MD. vd[j−1] of MD[j−1]. When the value of MD. vd[j−1] is larger, the whole process flow advances to Step S4. When the value of MD. vd[j−1] is not the larger one, the whole process flow advances to Step S5.

In Step S4, MD[j] and MD[j−1] are switched to each other. Specifically, all the elements included in MD[j] and all the elements included in MD[j−1] are switched to each other. As a result, the management information data set MD including the vertical display position MD. vd[i] with a smaller value is disposed closer to the head location in the order in which the management information data sets MD are stored.

In Step S5, the variable j is decremented.

In Step S6, it is determined whether or not the variable j is equal to the variable i. When it is equal, the whole process flow advances to Step S7. If it is not equal, the whole process flow returns to Step S3. In the case of advancing to Step S7, the vertical display position VDISP included in MD[i] is the smallest value within the range of MD[i] to MD[MDMAX]. In other words, the management information data sets MD stored at locations anterior to MD[i] (i=1 or more) are stored such that the vertical display positions VDISP thereof are in the order in which they are displayed.

In Step S7, the variable i is incremented.

In Step S8, it is determined whether or not the variable i is equal to the constant MDMAX. If it is equal, the process of aligning the management information data sets MD is completed. If it is not equal, the whole process flow returns to Step S2.

By the foregoing process, the management information data sets MD are aligned in the order in which the vertical display positions VDISP thereof become progressively larger from the head location in the order in which they are stored. At the stage at which the variable i has reached the constant MDMAX, the process of aligning the management information data sets MD is completed.

Although the present embodiment has shown an example which performs the process of aligning the management information data sets MD by using the bubble sort shown in Steps S1 through S8, the present invention is not limited thereto. It is also possible to use another algorithm, such as a quick sort, for the process of aligning the management information data sets MD.

In the OSD device 1 according to the present embodiment, a repeating process for repeatedly placing the OSD data set OD in the horizontal direction a number of times in accordance with the number-of-repeat-times information set REP can be performed with respect to the OSD data set OD. In the present embodiment, the repeating process is performed with the individual components controlled by a controller not shown. A description will be given herein below to a procedure for the repeating process.

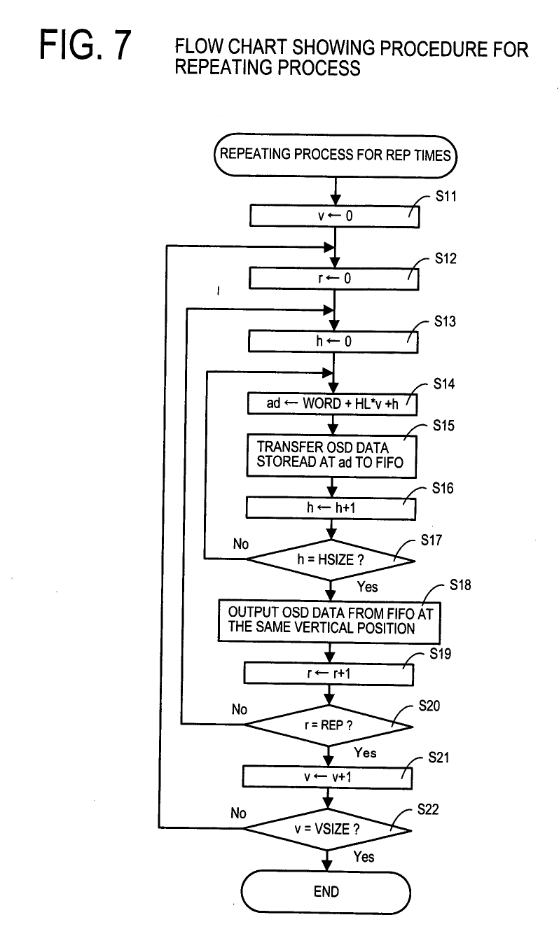

FIG. 7 is a flow chart showing a procedure for performing the repeating process the number of times included in the number-of-repeat-times information set REP.

The constant HL indicates the number of horizontal pixels in the sensed image data SD. The variables v, r, h, and ad are defined in the controller not shown and then used.

In Step S11, the variable v indicative of the vertical pixel position of the OSD data set OD as the target of transfer is initialized to 0.

In Step S12, the variable r for counting the number of repeat times is initialized to 0.

In Step S13, the variable h indicative of the horizontal pixel position of the OSD data set OD as the target of transfer is initialized to 0.

In Step S14, an arithmetic operation is performed in accordance with a numerical expression (WORD+HL*v+h) for the storage addresses of the next OSD data set OD to be retrieved and the result of the arithmetic operation is substituted in the variable ad.

In Step S15, the OSD data read address generation unit 23 is controlled such that the addresses specified by the variable ad are outputted, while the first FIFO input control unit 40 is controlled such that the OSD data set OD stored at the addresses is transferred to the first FIFO 50.

In Step S16, the variable h is incremented.

In Step S17, it is determined whether or not the variable h has reached the number of horizontal pixels HSIZE. If the variable h has reached it, the whole process flow advances to Step S18. If the variable h has not reached it, the whole process flow returns to Step S14. As a result, the OSD data OD is transferred in a quantity corresponding to the number of horizontal pixels HSIZE.

In Step S18, the data in the quantity corresponding to the number of horizontal pixels stored in the first FIFO 50 is outputted at the same vertical display position in continuous relation to the final location of the previous output position (when the output is the heading one, it is outputted from the head location shown by the horizontal display position HDISP).

In Step S19, the variable r is incremented. Further, in Step S20, it is determined whether or not the variable r has reached the value of the number-of-repeat-times information set REP. If the variable r has reached it, the whole process flow advances to Step S21. If the variable r has not reached it, the whole process flow returns to Step S13 where the transfer is repeated from the horizontal head pixel.

In Step S21, the variable v is incremented. Further, in Step S22, it is determined whether or not the variable v has reached the value of the number of vertical pixels VSIZE. If the variable v has reached it, it follows that the transfer of the number of vertical pixels is entirely completed and therefore the repeating process is ended. If the variable v has not reached it, the whole process flow returns to Step S12 where the transfer is started from the next vertical pixel position.

In the OSD device 1 according to the present embodiment, an enlargement process can also be performed with respect to the OSD data set OD by using a scaling factor based on the enlargement factor EXP. In the present embodiment, the enlargement process is performed with the individual components controlled by the controller not shown.

In the enlargement process performed in the OSD device 1 according to the present embodiment, vertical enlargement is accomplished by repeatedly transferring the same pixel in the quantity corresponding to the number of horizontal pixels HSIZE an N number of times. On the other hand, horizontal enlargement is accomplished by repeatedly outputting the same pixel the N number of times when parallel-to-serial conversion is performed with respect to the OSD data set OD such that a serial output is produced. Thus, the vertical enlargement and the horizontal enlargement process are performed individually and separately. A description will be given herein below to the vertical and horizontal enlargement processes in this order.

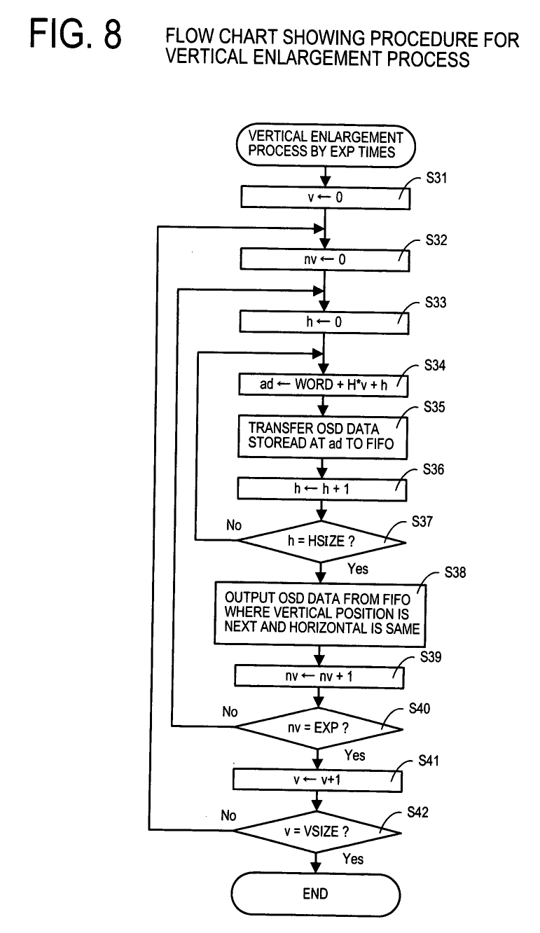

FIG. 8 is a flow chart showing a procedure for the vertical enlargement process performed with the scaling factor EXP.

The constant HL indicates the number of horizontal pixels in the sensed image data SD, while the variables h, v, and nv are defined in the controller not shown and then used.

In Step S31, the variable v indicative of the vertical pixel position of the OSD data set OD as the target of transfer is initialized to 0.

In Step S32, the variable nv for counting the number of repeat times in the vertical direction is initialized to 0.

In Step S33, the variable h indicative of the horizontal pixel position of the OSD data set OD as the target of transfer is initialized to 0.

In Step S34, an arithmetic operation is performed in accordance with a numerical expression (WORD+HL*v+h) for the storage addresses of the next OSD data set OD to be retrieved and the result of the arithmetic operation is substituted in the variable ad.

In Step S35, the OSD data read address generation unit 23 is controlled such that the addresses specified by the variable ad are outputted, while the first FIFO input control unit 40 is controlled such that the OSD data set OD stored at the addresses is transferred to the first FIFO 50.

In Step S36, the variable h is incremented.

In Step 37, it is determined whether or not the variable h has reached the number of horizontal pixels HSIZE. If the variable h has reached it, the whole process flow advances to Step S38. If the variable h has not reached it, the whole process flow returns to Step S34. As a result, the OSD data OD is transferred in the quantity corresponding to the number of horizontal pixels HSIZE.

In Step S38, the data in the quantity corresponding to the number of horizontal pixels HSIZE which has been stored in the first FIFO 50 is outputted from the display positions of which the vertical display position is the next line and the horizontal display position is indicated by the horizontal display position HDISP.

In Step S39, the variable nv is incremented. Further, in Step S40, it is determined whether or not the variable nv has reached the value of the enlargement factor EXP. If the variable nv has reached it, the whole process flow advances to Step S41. If the variable nv has not reached it, the whole process flow returns to Step S33 where the transfer is repeated from the horizontal head pixel.

In Step S41, the variable v is incremented. Further, in Step S42, it is determined whether or not the variable v has reached the value of the number of vertical pixels VSIZE. If the variable v has reached it, the vertical enlargement process is ended. If the variable v has not reached it, the whole process flow returns to Step S32 where the transfer is started from a pixel position in the (vertical) next line.

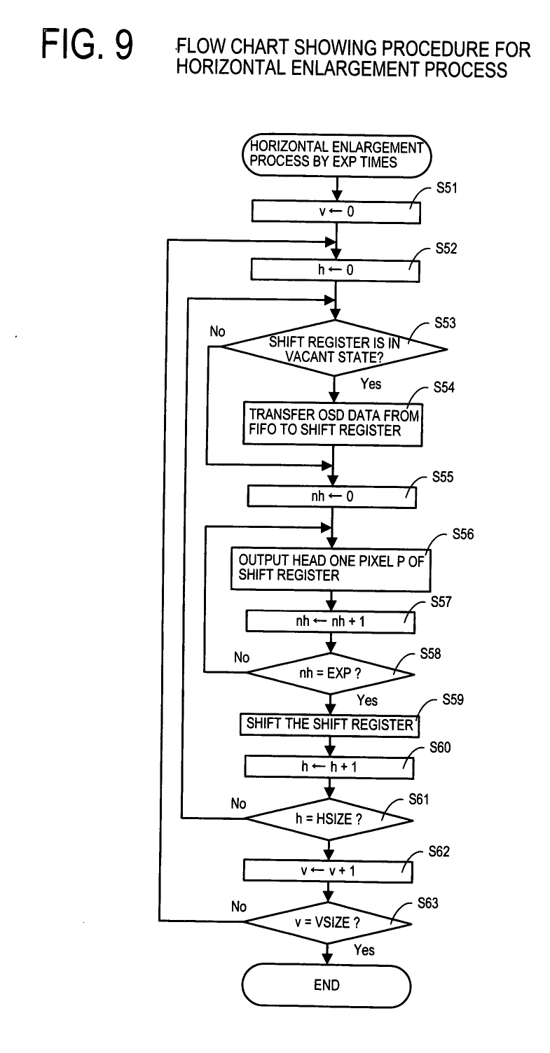

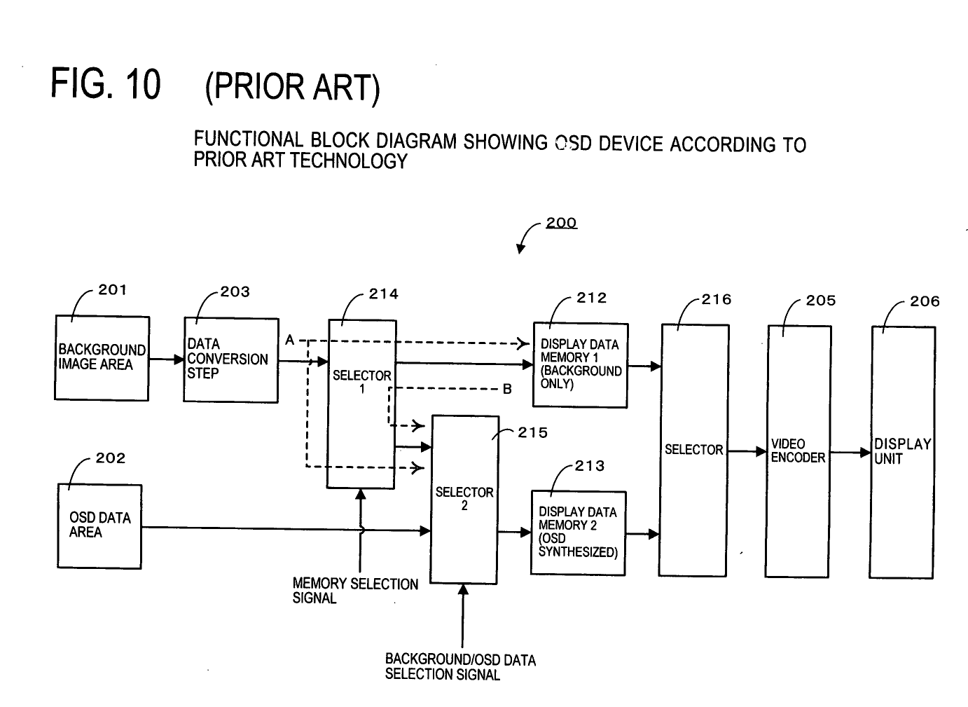

FIG. 9 is a flow chart showing a procedure for the horizontal enlargement process performed with the scaling factor EXP.

The variables h, v, and nh are defined in the controller not shown and then used.

In Step S51, the variable v indicative of the vertical pixel position of the OSD data set OD as the target of transfer is initialized to 0.

In Step S52, the variable h indicative of the horizontal pixel position of the OSD data set OD as the target of transfer is initialized to 0.

In Step S53, it is determined whether or not a shift register is in a vacant state without any OSD data set OD remaining to be outputted. If the shift register is in the vacant state, the whole process flow advances to Step S54. If the shift register is not in the vacant state, the whole process flow advances to Step S55.

In Step S54, the OSD data OD corresponding to one word is transferred from the first FIFO 50 to the shift register 61. In Step S55, the variable nh for counting the number of repeat times in the horizontal direction is initialized to 0.

In Step S56, that one of the OSD data sets OD stored in the shift register which corresponds to the head one pixel is outputted and the variable nh is incremented in Step S57.

In Step S58, it is determined whether or not the variable nh has reached the value of the enlargement factor EXP. If the variable nh has reached it, the whole process flow advances to Step S60. If the variable nh has not reached it, the whole process flow returns to Step S56. As a result, Step S56 is repeated by a number of times corresponding to the value of the enlargement factor EXP so that the same pixel is horizontally outputted in the quantity corresponding to the value of the enlargement factor EXP.

In Step S59, the shift register is shifted so that the pixel at the head position is updated. In Step S60, the variable h is incremented.

In Step S61, it is determined whether or not the variable h has reached the value of the number of horizontal pixels HSIZE. If the variable h has reached it, the whole process flow advances to Step S62. If the variable h has not reached it, the whole process flow returns to Step S53. As a result, pixels equivalent to the number of horizontal pixels HSIZE are subjected to the enlargement process.

In Step S62, the variable nv is incremented. Further, in Step S63, it is determined whether or not the variable v has reached the value of the number of vertical pixels VSIZE. If the variable v has reached it, the enlargement process is ended. If the variable v has not reached it, the whole process flow returns to Step S52.

It will easily be appreciated that the present invention is not limited to the embodiment described above and various improvements and modifications can be made within the scope not departing from the gist of the present invention.

For example, although the sensed image data storage region, the OSD data storage region, and the management information data storage region are provided on the same device (SDRAM) in the present embodiment, the present invention is not limited thereto. These storage regions may also be provided on different devices. For example, when the OSD device is composed of an LSI, it is also possible to provide the sensed image data storage region which requires a large capacity on an external SDRAM and provide the OSD data storage region and the management information data storage region each of which requires only a smaller capacity on the internal memory of the LSI.

The display color conversion unit can also perform the display color conversion by preparing pallet data in which 8 bits are assigned to 1 pixel as the OSD data set OD and having an internal RGB conversion table without providing the management information. Alternatively, the display color conversion unit can perform a single-color conversion process by assigning 1 bit to 1 pixel and having 8 bits for each color of RGB as the management information.

The sensed image data is an example of the first data. The sensed image data storage region is an example of the first storage unit. The OSD data set is an example of the second data set. The OSD data storage region is an example of the second data sets storage unit. The management information data storage region is an example of the management information storage unit. Each of the management information acquisition/retention unit and the comparison unit is an example of the management information acquisition unit. The first FIFO output control unit is an example of the output control unit. The management information read address generation unit is an example of the management information acquisition unit. The management information acquisition/retention unit is an example of the retention unit. The first FIFO is an example of the FIFO. The first FIFO input control unit is an example of the FIFO input control unit. The first FIFO output control unit is an example of the FIFO output control unit. The management information data alignment process (FIG. 6) is an example of the management information alignment unit. The repeating process (FIG. 7) is an example of the repeating unit. Each of the shift register, the vertical enlargement process (FIG. 8), and the horizontal enlargement process (FIG. 9) is an example of the enlargement unit.

By applying the present invention, it becomes possible to provide an OSD device which allows a reduction in the capacity of the memory for storing OSD data and also allows the more efficient use of a transfer frequency band in the transfer of the OSD data.

What is claimed is:

1. An on-screen display device for outputting second data sets in superimposed relation on parts of first data sets, said device comprising:
a second data sets storage unit for storing said second data sets at individual specified storage locations;
a management information storage unit for storing, for a display position of each of said second data sets superimposed on said first data sets, a management information set including a second data display position information set indicative of the display position of said second data set and a second data storage location information set indicative of a storage location of the second data set;
a management information acquisition unit for retrieving, from said management information storage unit, said management information sets having the second data display position information sets which match said first data display position as acquired management information sets; and
an output control unit for retrieving, from said second data sets storage unit, said second data sets to be stored in said second data storage location information sets included in said acquired management information sets.

2. An on-screen display device according to claim 1, further comprising:
a management information alignment unit for aligning said management information sets such that said second data display position information sets included in said management information sets are in an order in which they are displayed prior to the storage of said management information sets in said management information storage unit, wherein
said management information acquisition unit includes a management information retrieval unit for retrieving, from said management information storage unit, said management information sets in an order in which they are stored, a comparison unit for comparing each of said second data display position information sets included in the management information sets with said first data display position and determining whether or not they match, and a retention unit for retaining the management information sets as said acquired management information sets, wherein
when said comparison unit determines that they match, said retention unit updates the retained management information sets and said management information retrieval unit retrieves the next management information sets to be stored from said management information storage unit.

3. An on-screen display device according to claim 1, wherein
said management information set further includes, for the display position of each of said second data sets, a number-of-horizontal-pixels information set indicative of the number of pixels in a direction along a scan line in the second data set and a number-of-vertical-pixels information set indicative of the number of pixels in a direction orthogonal to the direction along the scan line in the second data set, said on-screen display device further comprising:
a FIFO for storing said second data set to be outputted;
a FIFO input control unit for transferring, to said FIFO, said second data set having the number of pixels obtained based on said number-of-horizontal-pixels information set and on said number-of-vertical-pixels information set from said storage location indicated by said second data storage location information set; and
a FIFO output control unit for outputting said second data set stored in said FIFO in accordance with said first data display position.

4. An on-screen display device according to claim 3, wherein
said FIFO input control unit includes a number-of-input-words counter for counting, for each input of said second data set, the number of words in said input second data set, a number-of-input-words determination unit for determining whether or not a value counted by said number-of-input-words counter has reached the number of words in accordance with the number of pixels in said second data set, and a transfer instruction signal generation unit for outputting an input instruction signal when a region capable of storing said second data set remains in said FIFO and when the number counted by said number-of-input-words counter has not reached the number of words in accordance with the number of pixels in said second data set, wherein
said second data set is inputted from said second data sets storage unit to said FIFO in response to the input instruction signal.

5. An on-screen display device according to claim 4, wherein said FIFO has a capacity which is the same as the one of said second data sets that has a maximum capacity.

6. An on-screen display device according to claim 1, further comprising:
a display color conversion unit for converting a display color of each of said second data sets to be outputted based on a display color information set specifying the display color of the second data set, wherein
said management information set further includes said display color information set for the display position of each of said second data sets.

7. An on-screen display device according to claim 1, further comprising:
an enlargement unit for performing an enlargement process with respect to each of said second data sets to be outputted based on a scaling factor information set as a scaling factor when the second data set is enlarged in each of a direction along a scan line and a direction orthogonal to the scan line, wherein
said management information set further includes said scaling factor information set for the display position of each of said second data sets.

8. An on-screen display device according to claim 1, further comprising:
a repeating unit for performing a repeating process with respect to each of said second data sets to be outputted based on a number-of-repeat-times information set indicative of the number of times of the repeating process for repeatedly placing the second data set in a direction along a scan line, wherein
said management information set further includes said number-of-repeat-times information set for the display position of each of said second data sets.

9. A method for controlling an on-screen display device for outputting second data sets in superimposed relation on parts of first data sets, said device comprising: a second data sets storage unit for storing said second data sets at individual specified storage locations; and a management information storage unit for storing, for a display position of each of said second data sets superimposed on said first data sets, a management information set including a second data display position information set indicative of the display position of said second data set and a second data storage location information set indicative of a storage location of the second data set, said method comprising the steps of:
retrieving, from said management information storage unit, said management information sets having the second data display position information sets which match said first data display position as acquired management information sets; and
retrieving, from said second data sets storage unit, said second data sets to be stored in said second data storage location information sets included in said acquired management information sets.

10. A method according to claim 9, further comprising the step of:
aligning said management information sets such that said second data display position information sets included in said management information sets are in an order in which they are displayed prior to the storage of said management information sets in said management information storage unit, wherein
said management information retrieval step includes the steps of retrieving, from said management information storage unit, said management information sets in an order in which they are stored, comparing each of said second data display position information sets included in the management information sets with said first data display position and determining whether or not they match, and retaining the management information sets as said acquired management information sets, wherein
when it is determined that they match in said determination and comparison step, said retention step includes updating the retained management information sets and said management information retrieval step includes retrieving the next management information sets to be stored from said management information storage unit.

11. A method according to claim 9, wherein
said management information set further includes, for the display position of each of said second data sets, a number-of-horizontal-pixels information set indicative of the number of pixels in a direction along a scan line in the second data set and a number-of-vertical-pixels information set indicative of the number of pixels in a direction orthogonal to the direction along the scan line in the second data set, said method further comprising the steps of:
transferring, to a FIFO for storing said second data set, said second data set having the number of pixels obtained based on said number-of-horizontal-pixels information set and on said number-of-vertical-pixels information set from said storage location indicated by said second data storage location information set; and
outputting said second data set stored in said FIFO in accordance with said first data display position.

12. A method according to claim 11, wherein
said step of inputting the second data set to the FIFO includes the steps of counting, for each input of said second data set, the number of words in said input second data set, determining whether or not a value counted in said step of counting the number of words has reached the number of words in accordance with the number of pixels in said second data set, and outputting an input instruction signal when a region capable of storing said second data set remains in said FIFO and when the value counted in said step of counting the number of words has not reached the number of words in accordance with the number of pixels in said second data set, wherein
said second data set is inputted from said second data sets storage unit to said FIFO in response to the input instruction signal.
